(19) United States
(12) Patent Application Publication
(10) Pub. No.: US 2025/0232189 A1
(43) Pub. Date: Jul. 17, 2025

(54) AUXILIARY DECISION-MAKING METHOD AND DEVICE FOR ILLEGAL FISHING INCIDENTS

(71) Applicant: Wuhan University of Technology, Wuhan (CN)

(72) Inventors: Hongchu Yu, Wuhan (CN); Yuhao Xiao, Wuhan (CN); Chen Chen, Wuhan (CN); Weihuang Wu, Wuhan (CN)

(21) Appl. No.: 18/679,520

(22) Filed: May 31, 2024

(30) Foreign Application Priority Data
Jan. 17, 2024 (CN) 2024100638995

(51) Int. Cl. G06Q 50/18; G06Q 50/02

(52) U.S. Cl. CPC G06N 5/01; G06F 16/3344; G06N 5/04; G06Q 50/02; G06Q 50/18

(57) ABSTRACT

Disclosed is an auxiliary decision-making method and device for illegal fishing incidents. The method comprises obtaining a historical illegal fishing case data set and a fishing case to be decided; preprocessing the fishing case to be decided and the multiple historical illegal fishing cases separately, and obtaining corresponding sentence vector to be decided and multiple historical sentence vectors; determining multiple similarity values between the sentence vector to be decided and multiple historical sentence vectors, and determining a target illegal fishing case corresponding to the fishing case to be decided in multiple historical illegal fishing cases; constructing a penalty amount prediction model, and inputting the fishing case to be determined into the penalty amount prediction model to obtain a predicted penalty amount for the fishing case to be determined. This disclosure can help relevant departments evaluate and handle illegal fishing incidents more scientifically and fairly.

### FIELD OF THE DISCLOSURE

The disclosure relates to the technical field of identification of illegal fishing, in particular to an auxiliary decision-making method and device for illegal fishing incidents.

### BACKGROUND

The current methods for determining whether fishing behavior is illegal and determining penalty amount mostly rely on manual inspection and decision-making, which cannot effectively stop illegal fishing behavior. There are often shortcomings such as strong subjectivity in judgment, reliance on professional experience, and susceptibility to errors.

Therefore, there is an urgent need to provide an auxiliary decision-making method and device for illegal fishing incidents to solve the above-mentioned technical problems.

### SUMMARY

The purpose of this disclosure is to provide an auxiliary decision-making method and device for illegal fishing incidents to solve the technical problems of low accuracy in identifying illegal fishing behaviors and unreasonable fines in existing technologies.

In order to solve the above technical problems, this disclosure provides an auxiliary decision-making method for illegal fishing incidents, comprising:
an auxiliary decision-making method for illegal fishing incidents, comprising:
obtaining a historical illegal fishing case data set and a fishing case to be decided; the historical illegal fishing case data set comprises multiple historical illegal fishing cases;
preprocessing the fishing case to be decided and the multiple historical illegal fishing cases separately, and obtaining corresponding sentence vector to be decided and multiple historical sentence vectors;
determining multiple similarity values between the sentence vector to be decided and multiple historical sentence vectors based on a similarity determination model, and determining a target illegal fishing case corresponding to the fishing case to be decided in multiple historical illegal fishing cases based on these similarity values;
constructing a penalty amount prediction model based on the historical illegal fishing case dataset, and inputting the fishing case to be determined into the penalty amount prediction model to obtain a predicted penalty amount for the fishing case to be determined; the data type for fishing cases to be determined is text data;
preprocessing the fishing case to be decided to obtain a sentence vector to be decided, comprising:
using the Jieba word segmentation tool to segment fishing cases to be decided and obtaining multiple case words;
processing the multiple case words based on a vectorized model to obtain multiple case word vectors;
determining multiple word weights for the multiple case words, and based on multiple word weights and the case word vectors, determining the sentence vector to be decided of the fishing case to be decided;
constructing a penalty amount prediction model based on the historical illegal fishing case data set, comprising:
determining the training subset in the historical illegal fishing case dataset; the training subset comprises multiple historical cases of illegal fishing;
determining the characteristic attributes of each historical illegal fishing case based on preset extraction rules;
encoding all branch results of feature attributes to obtain label encodings;
constructing a prediction model for the penalty amount to be pruned based on the label encodings, splitting indicators, and stopping tree indicators;
determining validation subsets in the historical illegal fishing case dataset and determining multiple subtrees of the penalty amount prediction model to be pruned;
based on the validation subsets and pruning evaluation indicators, determining the pruning evaluation values of each subtree; if the pruning evaluation value is greater than the evaluation standard value, pruning the subtree to obtain a penalty amount prediction model;
the prediction model for the penalty amount to be pruned comprises multiple splitting points, multiple historical illegal fishing cases are divided into a first subset and a second subset by the splitting points, and the splitting index is:

$${σ}_{n}^{2} = {n}_{1} \times {σ}_{1}^{2} + {n}_{2} \times {σ}_{2}^{2}$$

$${σ}_{1}^{2} = \sum {( {y}_{i} - {c}_{1} )}^{2}$$

$${σ}_{2}^{2} = \sum {( {y}_{j} - {c}_{2} )}^{2}$$

where, σₙ² is the weighted squared error of the splitting point; n is the number of cases in the first subset; σ₁² is the squared error of the first subset; n₂ is the number of cases in the second subset; σ₂² is the squared error of the second subset; yᵢ is the output value of the i-th historical illegal fishing case in the first subset; yⱼ is the output value of the j-th historical illegal fishing case in the second subset; c₁ is mean output of all historical illegal fishing cases in the first subset; c₂ is the mean output of all historical illegal fishing cases in the second subset;

### The Pruning Evaluation Indicator is:

$${C}_{α} ( T ) = C ( T ) + α \vert T \vert$$

where C_{α}(T) is the pruning evaluation value of the T-th subtree; C(T) is the mean square error obtained by running the validation subset in the T-th subtree; |T| is the number of leaf nodes in the sub number; a is a set parameter used to balance the fitting ability and complexity of the model;
wherein the stopping tree indicator in step S304 is the maximum height of the decision tree or the minimum number of samples in the node.

Compared with existing technologies, the beneficial effect of this disclosure is: this disclosure provides an auxiliary decision-making method for illegal fishing incidents, which preprocesses a fishing case to be decided and multiple historical illegal fishing cases to obtain a sentence vector to be decided and multiple historical sentence vectors; Based on the similarity determination model, multiple similarity values of the sentence vector to be decided and multiple historical sentence vectors are determined, and a target illegal fishing case corresponding to the fishing case to be decided in multiple historical illegal fishing cases are determined based on these similarity values. The target illegal fishing case with the highest similarity to the fishing case to be decided can be obtained from historical illegal fishing cases, which can provide decision support for the fishing case to be decided based on historical illegal fishing cases. Furthermore, due to the lack of completely consistent cases of illegal fishing, in order to ensure the reasonable setting of the penalty amount for the fishing case to be determined, this disclosure uses a penalty amount prediction model based on the historical illegal fishing case data set to predict the penalty amount for fishing case to be determined. This can further help relevant departments evaluate and handle illegal fishing incidents more scientifically and fairly, and achieve effective crackdown and prevention of illegal fishing behavior.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a flowchart of an embodiment of the auxiliary decision-making method for illegal fishing incidents provided by this disclosure;

FIG. 2 is a flowchart illustrating an embodiment of obtaining a sentence vector to be decided in S102 of FIG. 1 of this disclosure;

FIG. 3 is a flowchart of an embodiment of constructing the fine amount prediction model provided by this disclosure;

FIG. 4 is a schematic diagram of the structure of an embodiment of the fine amount prediction model provided by this disclosure;

FIG. 5 is a schematic diagram of an embodiment of evaluating the fine amount prediction model provided by this disclosure;

FIG. 6 is a schematic diagram of an embodiment of the auxiliary decision-making device for illegal fishing incidents provided by this disclosure;

FIG. 7 is a schematic diagram of an embodiment of the auxiliary decision-making device for illegal fishing incidents provided by this disclosure.

### DETAILED DESCRIPTION OF PREFERRED EMBODIMENTS

The technical solutions in the embodiments of the application will be described clearly and completely in combination with the drawings in the embodiments of the application.

This disclosure provides an auxiliary decision-making method and device for illegal fishing incidents. The following will be explained separately.

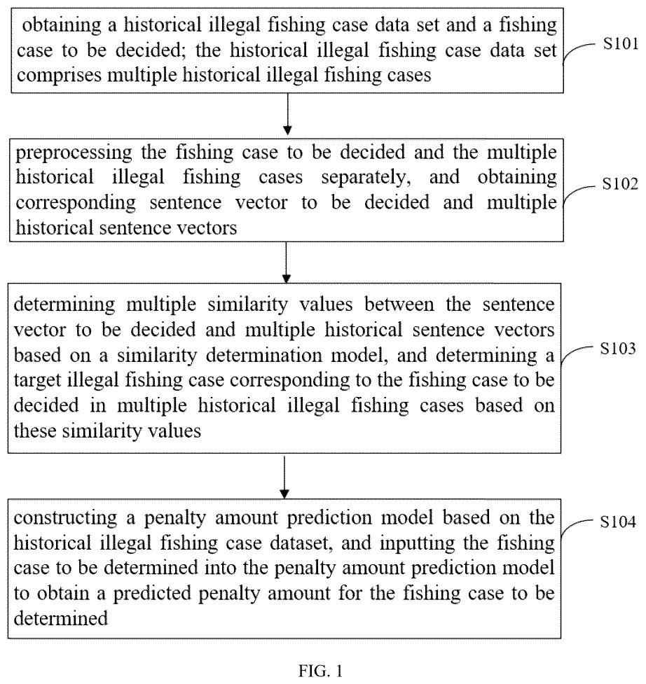

FIG. 1 is a flowchart of an embodiment of an auxiliary decision-making method for illegal fishing incidents provided by this disclosure, as shown in FIG. 1. The auxiliary decision-making method for illegal fishing incidents comprises:
S101, obtaining a historical illegal fishing case data set and a fishing case to be decided; the historical illegal fishing case data set comprises multiple historical illegal fishing cases;
S102, preprocessing the fishing case to be decided and the multiple historical illegal fishing cases separately, and obtaining corresponding sentence vector to be decided and multiple historical sentence vectors;
S103, determining multiple similarity values between the sentence vector to be decided and multiple historical sentence vectors based on a similarity determination model, and determining a target illegal fishing case corresponding to the fishing case to be decided in multiple historical illegal fishing cases based on these similarity values;
S104, constructing a penalty amount prediction model based on the historical illegal fishing case dataset, and inputting the fishing case to be determined into the penalty amount prediction model to obtain a predicted penalty amount for the fishing case to be determined.

Compared with existing technologies, this disclosure provides an auxiliary decision-making method for illegal fishing incidents, which preprocesses a fishing case to be decided and multiple historical illegal fishing cases to obtain a sentence vector to be decided and multiple historical sentence vectors; Based on the similarity determination model, multiple similarity values of the sentence vector to be decided and multiple historical sentence vectors are determined, and a target illegal fishing case corresponding to the fishing case to be decided in multiple historical illegal fishing cases are determined based on these similarity values. The target illegal fishing case with the highest similarity to the fishing case to be decided can be obtained from historical illegal fishing cases, which can provide decision support for the fishing case to be decided based on historical illegal fishing cases. Furthermore, due to the lack of completely consistent cases of illegal fishing, in order to ensure the reasonable setting of the penalty amount for the fishing case to be determined, this disclosure uses a penalty amount prediction model based on the historical illegal fishing case data set to predict the penalty amount for fishing case to be determined. This can further help relevant departments evaluate and handle illegal fishing incidents more scientifically and fairly, and achieve effective crackdown and prevention of illegal fishing behavior.

Wherein, the specific process of obtaining historical illegal fishing case data set in step S101 is to retrieve and download from the big data published in relevant websites to obtain historical illegal fishing case data set.

Among them, the historical illegal fishing case data set comprises but is not limited to: 1) basic information of illegal fishing cases, such as the year and region of case publication; 2) illegal fishing related information, such as illegal fishing operation mode, mesh size, catch weight and case value; 3) ecological damage repair information, such as the amount of compensation, repair measures.

It should be noted that in step S103, the target illegal fishing case is a historical illegal fishing case with a similarity value higher than a similarity threshold with the fishing case to be decided.

In an embodiment of this disclosure, the similarity threshold is 70%.

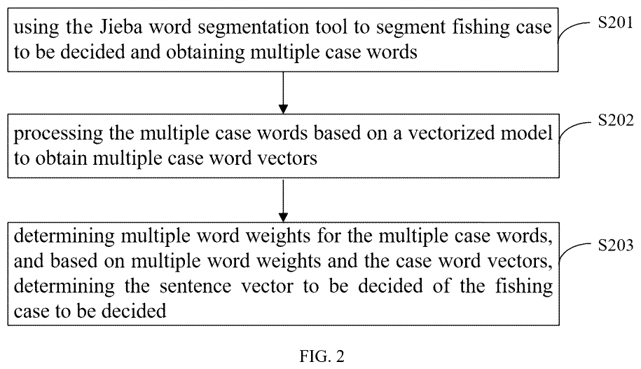

In some embodiments of this disclosure, the data type for fishing cases to be determined is text data; As shown in FIG. 2, in step S102, preprocessing the fishing case to be decided to obtain a sentence vector to be decided, comprising:
S201, using the Jieba word segmentation tool to segment fishing cases to be decided and obtaining multiple case words;
S202, processing the multiple case words based on a vectorized model to obtain multiple case word vectors;
S203, determining multiple word weights for the multiple case words, and based on multiple word weights and the case word vectors, determining the sentence vector to be decided of the fishing case to be decided.

It should be noted that in order to ensure the accuracy of word segmentation processing in step S201, before executing step S201, the following three processing methods should be performed in the Jieba word segmentation tool: 1) adding a custom dictionary containing professional words related to maritime transportation; 2) stopping word filtering; 3) using precise mode segmentation.

Among them, the vectorized model in step S202 can be the Word2Vec model.

It should be understood that the method and steps for preprocessing multiple historical illegal fishing cases in step S102 are the same as those for preprocessing fishing cases to be decided. Please refer to steps S201 to S203 above, which will not be repeated here.

In some embodiments of this disclosure the sentence vector to be determined is:

$$sen\_vec = \frac{{\sum }_{i}^{m} v e {c}_{i} * {λ}_{n o r {m}_{i}}}{m}$$

$${μ}_{n o r m} = \frac{μ}{\sqrt{{\sum }_{i = 1}^{m} ( T F - I D {F}_{i}^{2} )}}$$

$${μ}_{n o r m} = ( {λ}_{{norm}_{1}} , {λ}_{{norm}_{2}} , … , {λ}_{n o r {m}_{m}} )$$

$$μ = ( T F - I D {F}_{1} , T F - I D {F}_{2} , … , TF - I D {F}_{m} )$$

$$TF - {IDF}_{i} = t {f}_{i} * {idf}_{i}$$

$${tf}_{i} = N ( i \vert D )$$

$${idf}_{i} = log ( \frac{n + 1}{N ( D \vert i ) + 1} ) + 1$$

where, sen_vec is the sentence vector to be determined; vecᵢ is the case word vector for the i-th case word; λₙₒᵣₘ is the normalized TF-IDF weight values for i-th case word; μ is the TF-IDF weight value vector for all case words; μₙₒᵣₘ is the normalized TF-IDF weight value vector for all case words; m is the number of all case words in the fishing case to be decided; TF-IDFᵢ is the original TF-IDF weight value for the i-th case word; n is the number of the historical illegal fishing cases; tfᵢ is the word frequency of case word i; idfᵢ is the inverse word frequency of case word i; N(i|D) is the number of times the i-th case word appears in illegal fishing case D; N(D|i) is the number of illegal fishing cases containing the case word i.

Due to the possibility of missing data in historical illegal fishing cases, if missing data is filled in, it is necessary to fill in subjective estimation values of humans, which may not fully conform to objective facts. In order to avoid the impact of unreasonable data supplementation on the results of auxiliary decision-making, in some embodiments of this disclosure, before step S102, it also comprises:
identifying missing cases with missing data in multiple historical illegal fishing cases and eliminating them.

The embodiment of this disclosure eliminates missing cases and achieves the use of data that fully conforms to objective facts for auxiliary decision-making, improving the accuracy of auxiliary decision-making.

In some embodiments of this disclosure, the similarity determination model is:

$$similarity = \frac{{sen\_vec}_{A} \cdot {sen\_vec}_{B}}{‖ {sen\_vec}_{A} ‖ \times ‖ {sen\_vec}_{B} ‖}$$

where, sen_vec_{A} is the sentence vector of fishing case A; sen_vec_{B} is the sentence vector of fishing case B; ∥ ∥ is the symbol for modulo operation.

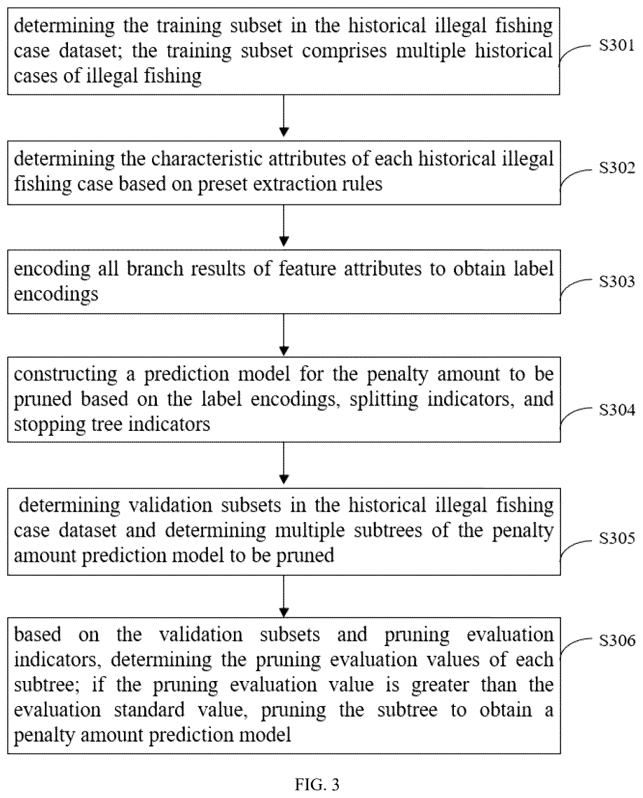

In some embodiments of this disclosure, as shown in FIG. 3, in step S104, constructing a penalty amount prediction model based on the historical illegal fishing case data set, comprising:
S301, determining the training subset in the historical illegal fishing case dataset; the training subset comprises multiple historical cases of illegal fishing;
S302, determining the characteristic attributes of each historical illegal fishing case based on preset extraction rules;
S303, encoding all branch results of feature attributes to obtain label encodings;
S304, constructing a prediction model for the penalty amount to be pruned based on the label encodings, splitting indicators, and stopping tree indicators;
S305, determining validation subsets in the historical illegal fishing case dataset and determining multiple subtrees of the penalty amount prediction model to be pruned;
S306, based on the validation subsets and pruning evaluation indicators, determining the pruning evaluation values of each subtree; if the pruning evaluation value is greater than the evaluation standard value, pruning the subtree to obtain a penalty amount prediction model.

The embodiment of this disclosure prunes the penalty amount prediction model based on the validation subsets to obtain a penalty amount prediction model, which can avoid overfitting and improve the generalization ability of the penalty amount prediction model.

In an embodiment of this disclosure, step S302 specifically comprises: extracting the following seven feature attributes: 1) are rare fish species being caught? There are two types of branch results: 1. Yes, 2. No. 2) What fishing gear is used? The branching results are as follows: 1. Mesh smaller than the specified net or bottom trawl; 2. Hanging rod or overly efficient fishing tools; 3. Other. 3) What fishing practices are used? The branch results are as follows: 1. Electrizing fish, poisoning fish, bombing fish, 2. Boat knocking operation, 3. Fishing with fish eagles, 4. Others. 4) Where is the fishing area located? The branch results are as follows: 1. Marine waters, 2. Inland waters, 3. Protected watersheds such as the Yangtze River. 5) Do you hold a fishing license? There are two types of branch results: 1. Yes, 2. No. 6) Do you hold a vessel navigation certificate? There are two types of branch results: 1. Yes, 2. No. 7) What is the amount of catch caught during fishing? The branch results are three types: 1. bar level (small amount), 2. kilogram level (large amount), and 3. ton level (large amount).

Among them, step S303 specifically comprises: dividing the seven feature attributes mentioned above into 19 types based on their branching results for selecting the splitting nodes of the penalty amount prediction model to be pruned. And the encoding method is one-hot encoding. Among them, 19 branch results are specifically: the first feature attribute comprises two branch results: yes or no, and the second feature attribute comprises three branch results. The branch results of the seven feature attributes are added together, resulting in a total of 19 branch results.

It should be noted that step S304 specifically comprises: using the label encodings as different splitting points, determining splitting index value for each splitting point based on the splitting index, using the splitting point corresponding to the minimum splitting index value as the actual splitting point, and so on, to construct a prediction model for the penalty amount to be pruned.

In some embodiments of this disclosure, multiple historical illegal fishing cases are divided into a first subset and a second subset by the splitting points, and the splitting index is:

$${σ}_{n}^{2} = {n}_{1} \times {σ}_{1}^{2} + {n}_{2} \times {σ}_{2}^{2}$$

$${σ}_{1}^{2} = \sum {( {y}_{i} - {c}_{1} )}^{2}$$

$${σ}_{2}^{2} = \sum {( {y}_{j} - {c}_{2} )}^{2}$$

where, σₙ² is the weighted squared error of the splitting point; n is the number of cases in the first subset; σ₁² is the squared error of the first subset; n₂ is the number of cases in the second subset; σ₂² is the squared error of the second subset; yᵢ is the output value of the i-th historical illegal fishing case in the first subset; yⱼ is the output value of the j-th historical illegal fishing case in the second subset; c₁ is mean output of all historical illegal fishing cases in the first subset; c₂ is the mean output of all historical illegal fishing cases in the second subset.

Among them, the stopping tree indicator in step S304 is the maximum height of the decision tree or the minimum number of samples in the node.

In the specific embodiment of this disclosure, the pruning evaluation indicator is:

$${C}_{α} ( T ) = C ( T ) + α \vert T \vert$$

where C_{α}(T) is the pruning evaluation value of the T-th subtree; C(T) is the mean square error obtained by running the validation subset in the T-th subtree; |T| is the number of leaf nodes in the sub number; α is a set parameter used to balance the fitting ability and complexity of the model.

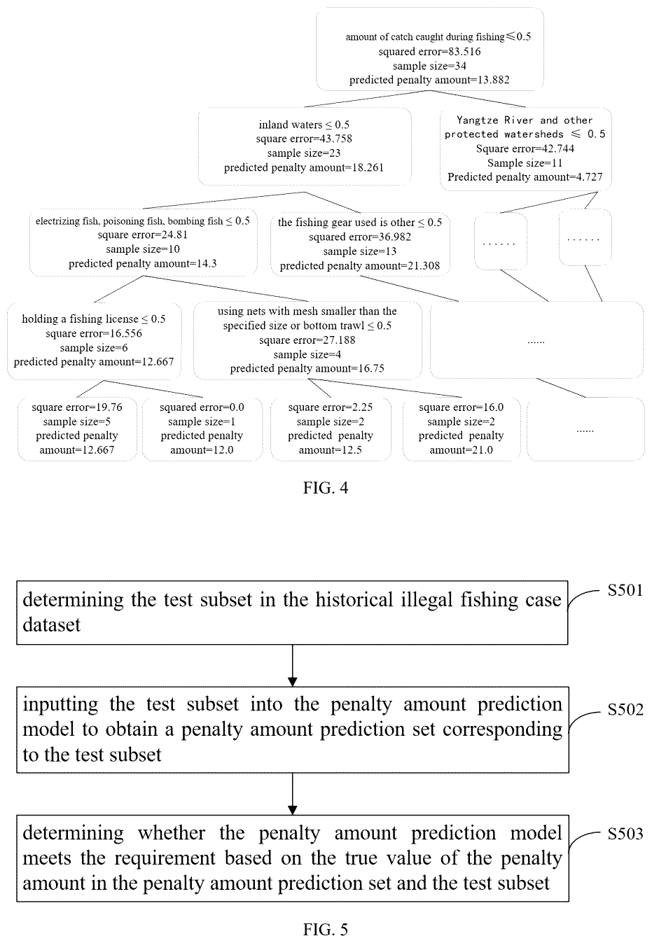

In an embodiment of this disclosure, as shown in FIG. 4 (some nodes are not shown in FIG. 4, ellipses are used to replace the specific content), the construction process of the penalty amount prediction model is as follows: setting the depth of the penalty amount prediction model to 4, and the original data volume is 43 case data, which are divided into a training set (34 case data) and a testing set (9 case data). According to the calculation of the squared error of the split indicator value, the root node selects whether the catch quantity is in the kilogram level (large quantity). The training set branches through a binary structure, and data cases with catch quantities in the kilogram level are diverted to the left sub node. The judgment criterion is whether the fishing area is in the ocean, with a total of 23 case data. The data cases with fishing quantities not in the kilogram level are diverted to the right sub node, and the judgment basis is whether the fishing area is inland water. There are a total of 11 case data. Based on each new sub-node mentioned above, the square error of all label encoding will be repeatedly calculated, and the label that minimizes it will be selected for further partitioning. This process will recursively continue until the decision tree model reaches a depth of 4.

To test the accuracy of the penalty amount prediction model constructed for this disclosure, in some embodiments, as shown in FIG. 5, after step S306, it also comprises:
S501, determining the test subset in the historical illegal fishing case dataset;
S502, inputting the test subset into the penalty amount prediction model to obtain a penalty amount prediction set corresponding to the test subset;
S503, determining whether the penalty amount prediction model meets the requirement based on the true value of the penalty amount in the penalty amount prediction set and the test subset.

Wherein, step S503 specifically comprises: if the difference between the true value of the penalty amount and the predicted value of the penalty amount in the penalty amount prediction set is greater than a preset difference, the penalty amount prediction model does not meet the requirement and needs to be retrained. If the difference between the actual value of the penalty amount and the predicted value of the penalty amount in the penalty amount prediction set is less than or equal to the preset difference, the penalty amount prediction model meets the requirement and can be used to make actual predictions of the penalty amount based on the penalty amount prediction model.

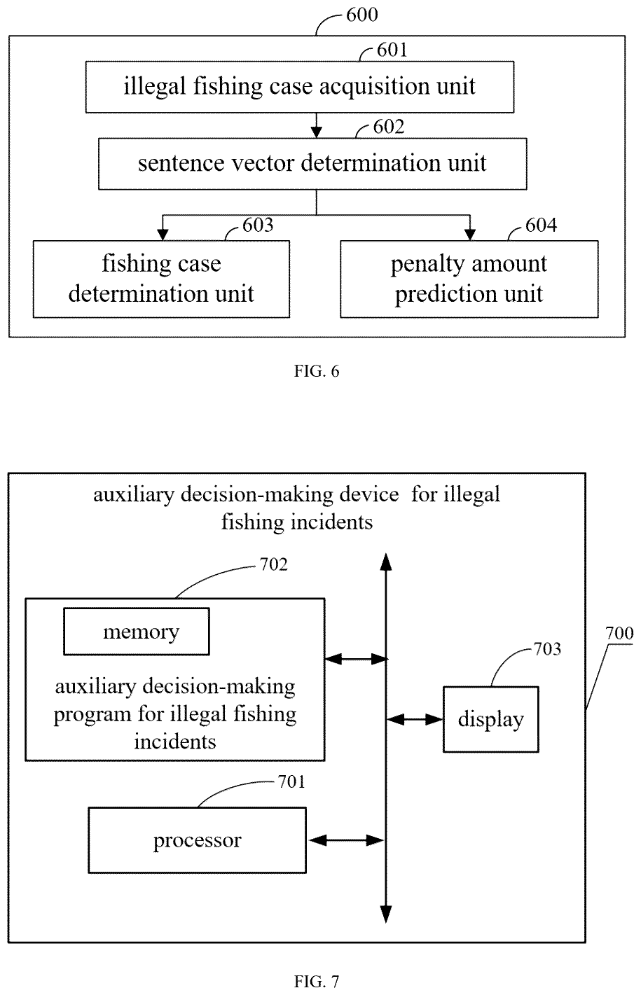

In order to better implement the auxiliary decision-making method for illegal fishing incidents in this disclosure, based on the auxiliary decision-making method for illegal fishing incidents, this disclosure also provides an auxiliary decision-making device for illegal fishing incidents, as shown in FIG. 6. The auxiliary decision-making device 600 for illegal fishing incidents comprises:
the illegal fishing case acquisition unit 601, which is used to obtain a historical illegal fishing case data set and a fishing case to be decided; the historical illegal fishing case data set comprises multiple historical illegal fishing cases;
the sentence vector determination unit 602, which is used to preprocess the fishing case to be decided and the multiple historical illegal fishing cases separately, and obtain corresponding sentence vector to be decided and multiple historical sentence vectors;
the fishing case determination unit 603, which is used to determine multiple similarity values between the sentence vector to be decided and multiple historical sentence vectors based on a similarity determination model, and determine a target illegal fishing case corresponding to the fishing case to be decided in multiple historical illegal fishing cases based on these similarity values;
the penalty amount prediction unit 604, which is used to construct a penalty amount prediction model based on the historical illegal fishing case dataset, and input the fishing case to be determined into the penalty amount prediction model to obtain a predicted penalty amount for the fishing case to be determined.

The auxiliary decision-making device 600 for illegal fishing incidents provided in the above embodiments can achieve the technical solution described in the embodiment of the auxiliary decision-making method for illegal fishing incidents. The specific implementation principles of the above modules or units can be found in the corresponding content of the embodiments of the auxiliary decision-making method for illegal fishing incidents, and will not be repeated here.

As shown in FIG. 7, this disclosure also provides an auxiliary decision-making device 700 for illegal fishing incidents. The auxiliary decision-making device 700 for the illegal fishing incidents comprises a processor 701, a memory 702, and a display 703. FIG. 7 only shows some components of the auxiliary decision-making device 700 for illegal fishing incidents, but it should be understood that it is not required to implement all the shown components, and more or fewer components can be implemented as substitutes.

In some embodiments, the processor 701 may be a Central Processing Unit (CPU), a microprocessor, or other data processing chip used to run program code stored in memory 702 or process data, such as auxiliary decision-making method for illegal fishing incidents in this disclosure.

In some embodiments, the processor 701 may be a single server or a group of servers. The server group can be centralized or distributed. In some embodiments, the processor 701 may be local or remote. In some embodiments, the processor 701 may be implemented on a cloud platform. In one embodiment, the cloud platform may comprise private cloud, public cloud, hybrid cloud, community cloud, distributed cloud, inter internal, multi cloud, or any combination of the above.

The memory 702 may be an internal storage unit of the auxiliary decision-making device 700 for illegal fishing incidents in some embodiments, such as a hard disk or memory of the auxiliary decision-making device 700 for illegal fishing incidents. The memory 702 can also be an external storage device of the auxiliary decision-making device 700 for illegal fishing incidents in other embodiments, such as a plug-in hard disk, a Smart Media Card (SMC), a Secure Digital (SD) card, a Flash Card, etc. equipped on the auxiliary decision-making device 700 for illegal fishing incidents.

Furthermore, the memory 702 may comprise both internal storage units of the auxiliary decision-making device 700 for illegal fishing incidents and external storage devices. The memory 702 is used to store the application software and various data of the auxiliary decision-making device 700 for the installation of illegal fishing incidents.

In some embodiments, the display 703 can be an LED display, LCD display, touch LCD display, and OLED (Organic Light Emitting Diode) touchscreen. The display 703 is used to display information on the auxiliary decision-making device 700 for illegal fishing incidents and to display a visual user interface. The components 701-703 of the auxiliary decision-making equipment 700 for illegal fishing incidents communicate with each other through system bus.

In one embodiment, when the processor 701 executes the auxiliary decision-making program for illegal fishing incidents in the memory 702, the following steps can be achieved:
obtaining a historical illegal fishing case data set and a fishing case to be decided; the historical illegal fishing case data set comprises multiple historical illegal fishing cases;
preprocessing the fishing case to be decided and the multiple historical illegal fishing cases separately, and obtaining corresponding sentence vector to be decided and multiple historical sentence vectors;
determining multiple similarity values between the sentence vector to be decided and multiple historical sentence vectors based on a similarity determination model, and determining a target illegal fishing case corresponding to the fishing case to be decided in multiple historical illegal fishing cases based on these similarity values;
constructing a penalty amount prediction model based on the historical illegal fishing case dataset, and inputting the fishing case to be determined into the penalty amount prediction model to obtain a predicted penalty amount for the fishing case to be determined.

It should be understood that when the processor 701 executes the auxiliary decision-making program for illegal fishing incidents in the memory 702, in addition to the above functions, it can also implement other functions, as described in the corresponding method implementation examples earlier.

Furthermore, this disclosure does not impose specific limitations on the types of auxiliary decision-making device 700 for illegal fishing incidents mentioned. The auxiliary decision-making devices 700 for illegal fishing incidents can be portable auxiliary decision-making devices such as mobile phones, tablets, personal digital assistants (PDAs), wearable devices, laptops, etc. Example embodiments of portable decision-making devices for illegal fishing incidents include, but are not limited to, portable decision-making devices for illegal fishing incidents equipped with IOS, Android, Microsoft, or other operating systems. The above-mentioned portable decision-making devices for illegal fishing incidents can also be decision-making devices for other portable illegal fishing incidents, such as laptops with touch sensitive surfaces (such as touch panels). It should also be understood that in some other embodiments of this disclosure, the auxiliary decision-making device 700 for illegal fishing incidents may not be a portable auxiliary decision-making device for illegal fishing incidents, but a desktop computer with a touch sensitive surface (such as a touch panel).

Correspondingly, the embodiment also provides a computer-readable storage medium for storing programs or instructions that can be read by a computer. When a program or an instruction is executed by a processor, it can achieve the steps or functions of the auxiliary decision-making methods for illegal fishing incidents provided in the above method embodiments.

Technicians in this field can understand that all or part of the process of implementing the above embodiments can be completed by instructing relevant hardware (such as processors, controllers, etc.) through computer programs, which can be stored in computer-readable storage media. Among them, computer-readable storage media include disks, optical discs, read-only storage memory, or random storage memory.

The above provides a detailed introduction to the auxiliary decision-making methods and devices for illegal fishing incidents provided by this disclosure. This disclosure applies specific examples to explain the principles and implementation methods. The above embodiments are only used to help understand the methods and core ideas of this disclosure; Meanwhile, for technical personnel in this field, there may be changes in specific implementation methods and application scope based on the concept of this disclosure. In summary, the content of this manual should not be understood as a limitation on this disclosure.

It is to be understood, however, that even though numerous characteristics and advantages of this disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An auxiliary decision-making method for illegal fishing incidents, comprising:
obtaining a historical illegal fishing case data set and a fishing case to be decided by a receiver from websites; the historical illegal fishing case data set comprises multiple historical illegal fishing cases;
preprocessing the fishing case to be decided and the multiple historical illegal fishing cases separately, and obtaining corresponding sentence vector to be decided and multiple historical sentence vectors;
determining multiple similarity values between the sentence vector to be decided and multiple historical sentence vectors based on a similarity determination model, and determining a target illegal fishing case corresponding to the fishing case to be decided in multiple historical illegal fishing cases based on these similarity values;
constructing a penalty amount prediction model based on the historical illegal fishing case dataset, and inputting the fishing case to be determined into the penalty amount prediction model to obtain a predicted penalty amount for the fishing case to be determined, wherein the predicted penalty amount is configured for determining whether the fishing case to be determined is illegal and managing and stopping an illegal fishing behavior of the fishing case to be determined if the fishing case is illegal by mobile terminals;
the data type for fishing cases to be determined is text data; wherein, preprocessing the fishing case to be decided and the multiple historical illegal fishing cases separately, and obtaining corresponding sentence vector to be decided and multiple historical sentence vectors, comprises:
using a Jieba word segmentation tool to segment fishing case to be decided and obtaining multiple case words;
processing the multiple case words based on a vectorized model to obtain multiple case word vectors;
determining multiple word weights for the multiple case words, and based on multiple word weights and the case word vectors, determining the sentence vector to be decided of the fishing case to be decided;
wherein, constructing a penalty amount prediction model based on the historical illegal fishing case data set, comprises:
determining the training subset in the historical illegal fishing case dataset; the training subset comprises multiple historical cases of illegal fishing;
determining the characteristic attributes of each historical illegal fishing case based on preset extraction rules;
encoding all branch results of feature attributes to obtain label encodings;
constructing a prediction model for the penalty amount to be pruned based on the label encodings, splitting indicators, and stopping tree indicators;
determining validation subsets in the historical illegal fishing case dataset and determining multiple subtrees of the penalty amount prediction model to be pruned;
based on the validation subsets and pruning evaluation indicators, determining the pruning evaluation values of each subtree; if the pruning evaluation value is greater than an evaluation standard value, pruning the subtree to obtain a penalty amount prediction model;
wherein the prediction model for the penalty amount to be pruned comprises multiple splitting points, multiple historical illegal fishing cases are divided into a first subset and a second subset by the splitting points, and the splitting index is:
$${σ}_{n}^{2} = {n}_{1} \times {σ}_{1}^{2} + {n}_{2} \times {σ}_{2}^{2}$$
$${σ}_{1}^{2} = \sum {( {y}_{i} - {c}_{1} )}^{2}$$
$${σ}_{2}^{2} = \sum {( {y}_{j} - {c}_{2} )}^{2}$$
where, σₙ² is the weighted squared error of the splitting point; n₁ is the number of cases in the first subset; σ₁² is the squared error of the first subset; n₂ is the number of cases in the second subset; σ₂² is the squared error of the second subset; yᵢ is the output value of the i-th historical illegal fishing case in the first subset; yⱼ is the output value of the j-th historical illegal fishing case in the second subset; c₁ is mean output of all historical illegal fishing cases in the first subset; c₂ is the mean output of all historical illegal fishing cases in the second subset;
the pruning evaluation indicator is:
$${C}_{α} ( T ) = C ( T ) + α \vert T \vert$$
where C_{α}(T) is the pruning evaluation value of the T-th subtree; C(T) is the mean square error obtained by running the validation subset in the T-th subtree; |T| is the number of leaf nodes in the sub number; α is a set parameter used to balance the fitting ability and complexity of the model;
wherein the stopping tree indicator is the maximum height of a decision tree or the minimum number of samples in the node.

2. The auxiliary decision-making method for illegal fishing incidents according to claim 1, wherein the sentence vector to be decided is:
$$sen\_vec = \frac{{\sum }_{i}^{m} v e {c}_{i} * {λ}_{n o r {m}_{i}}}{m}$$
$${μ}_{n o r m} = \frac{μ}{\sqrt{{\sum }_{i = 1}^{m} ( T F - I D {F}_{i}^{2} )}}$$
$${μ}_{n o r m} = ( {λ}_{{norm}_{1}} , {λ}_{{norm}_{2}} , … , {λ}_{n o r {m}_{m}} )$$
$$μ = ( T F - I D {F}_{1} , T F - I D {F}_{2} , … , TF - I D {F}_{m} )$$
$$TF - {IDF}_{i} = t {f}_{i} * {idf}_{i}$$
$${tf}_{i} = N ( i \vert D )$$
$${idf}_{i} = log ( \frac{n + 1}{N ( D \vert i ) + 1} ) + 1$$
where, sen_vec is the sentence vector to be determined; vecᵢ is the case word vector for the i-th case word; λₙₒᵣₘ_{ᵢ} is the normalized TF-IDF weight values for i-th case word; P is the TF-IDF weight value vector for all case words; μₙₒᵣₘ is the normalized TF-IDF weight value vector for all case words; m is the number of all case words in the fishing case to be decided; TF-IDFᵢ is the original TF-IDF weight value for the i-th case word; n is the number of the historical illegal fishing cases; tfᵢ is the word frequency of case word i; idfᵢ is the inverse word frequency of case word i; N(i|D) is the number of times the i-th case word appears in illegal fishing case D; N(D|i) is the number of illegal fishing cases containing the case word i.

3. The auxiliary decision-making method for illegal fishing incidents according to claim 1, before the step that preprocessing the fishing case to be decided and the multiple historical illegal fishing cases separately, it also comprises:
identifying missing cases with missing data in multiple historical illegal fishing cases and eliminating them.

4. The auxiliary decision-making method for illegal fishing incidents according to claim 1, the similarity determination model is:
$$similarity = \frac{{sen\_vec}_{A} \cdot {sen\_vec}_{B}}{‖ {sen\_vec}_{A} ‖ \times ‖ {sen\_vec}_{B} ‖}$$
where, sen_vec_{A} is the sentence vector of fishing case A; sen_vec_{B} is the sentence vector of fishing case B; ∥ ∥ is the symbol for modulo operation.

5. The auxiliary decision-making method for illegal fishing incidents according to claim 1, after the step that based on the validation subsets and pruning evaluation indicators, determining the pruning evaluation values of each subtree; if the pruning evaluation value is greater than the evaluation standard value, pruning the subtree to obtain a penalty amount prediction model, it also comprises:
determining a test subset in the historical illegal fishing case dataset;
inputting the test subset into the penalty amount prediction model to obtain a penalty amount prediction set corresponding to the test subset;
determining whether the penalty amount prediction model meets the requirement based on the true value of the penalty amount in the penalty amount prediction set and the test subset.

6. An auxiliary decision-making device for illegal fishing incidents, comprising:
at least one processor; and
a memory configured to store one or more programs which, when executed by the processor, cause the processor to:
obtain a historical illegal fishing case data set and a fishing case to be decided by a receiver from websites; the historical illegal fishing case data set comprises multiple historical illegal fishing cases;
preprocess the fishing case to be decided and the multiple historical illegal fishing cases separately, and obtain corresponding sentence vector to be decided and multiple historical sentence vectors;
determine multiple similarity values between the sentence vector to be decided and multiple historical sentence vectors based on a similarity determination model, and determine a target illegal fishing case corresponding to the fishing case to be decided in multiple historical illegal fishing cases based on these similarity values;
construct a penalty amount prediction model based on the historical illegal fishing case dataset, and input the fishing case to be determined into the penalty amount prediction model to obtain a predicted penalty amount for the fishing case to be determined, wherein the predicted penalty amount is configured for determining whether the fishing case to be determined is illegal and managing and stopping an illegal fishing behavior of the fishing case to be determined if the fishing case is illegal by mobile terminals;
the data type for fishing cases to be determined is text data;
wherein, preprocessing the fishing case to be decided and the multiple historical illegal fishing cases separately, and obtaining corresponding sentence vector to be decided and multiple historical sentence vectors, comprises:
using a Jieba word segmentation tool to segment fishing case to be decided and obtaining multiple case words;
processing the multiple case words based on a vectorized model to obtain multiple case word vectors;
determining multiple word weights for the multiple case words, and based on multiple word weights and the case word vectors, determining the sentence vector to be decided of the fishing case to be decided;
wherein, constructing a penalty amount prediction model based on the historical illegal fishing case data set, comprises:
determining the training subset in the historical illegal fishing case dataset; the training subset comprises multiple historical cases of illegal fishing;
determining the characteristic attributes of each historical illegal fishing case based on preset extraction rules;
encoding all branch results of feature attributes to obtain label encodings;
constructing a prediction model for the penalty amount to be pruned based on the label encodings, splitting indicators, and stopping tree indicators;
determining validation subsets in the historical illegal fishing case dataset and determining multiple subtrees of the penalty amount prediction model to be pruned;
based on the validation subsets and pruning evaluation indicators, determining the pruning evaluation values of each subtree; if the pruning evaluation value is greater than an evaluation standard value, pruning the subtree to obtain a penalty amount prediction model;
wherein the prediction model for the penalty amount to be pruned comprises multiple splitting points, multiple historical illegal fishing cases are divided into a first subset and a second subset by the splitting points, and the splitting index is:
$${σ}_{n}^{2} = {n}_{1} \times {σ}_{1}^{2} + {n}_{2} \times {σ}_{2}^{2}$$
$${σ}_{1}^{2} = \sum {( {y}_{i} - {c}_{1} )}^{2}$$
$${σ}_{2}^{2} = \sum {( {y}_{j} - {c}_{2} )}^{2}$$
where, σₙ² is the weighted squared error of the splitting point; n₁ is the number of cases in the first subset; σ₁² is the squared error of the first subset; n₂ is the number of cases in the second subset; σ₂² is the squared error of the second subset; yᵢ is the output value of the i-th historical illegal fishing case in the first subset; yⱼ is the output value of the j-th historical illegal fishing case in the second subset; c₁ is mean output of all historical illegal fishing cases in the first subset; C₂ is the mean output of all historical illegal fishing cases in the second subset;
the pruning evaluation indicator is:
$${C}_{α} ( T ) = C ( T ) + α \vert T \vert$$
where C_{α}(T) is the pruning evaluation value of the T-th subtree; C(T) is the mean square error obtained by running the validation subset in the T-th subtree; |T| is the number of leaf nodes in the sub number; a is a set parameter used to balance the fitting ability and complexity of the model;
wherein the stopping tree indicator is the maximum height of the decision tree or the minimum number of samples in the node.
